(19) United States
(12) Patent Application Publication
(10) Pub. No.: US 2023/0169348 A1
(43) Pub. Date: Jun. 1, 2023

(54) SEMANTIC SEGMENTATION USING A TARGETED TOTAL VARIATION LOSS

(71) Applicants: Martin Ivanov GERDZHEV, Toronto (CA); Ehsan TAGHAVI, Markham (CA); Ryan RAZANI, Toronto (CA); Bingbing LIU, Markham (CA)

(72) Inventors: Martin Ivanov GERDZHEV, Toronto (CA); Ehsan TAGHAVI, Markham (CA); Ryan RAZANI, Toronto (CA); Bingbing LIU, Markham (CA)

(21) Appl. No.: 18/160,662

(22) Filed: Jan. 27, 2023

Related U.S. Application Data
(63) Continuation of application No. PCT/CA21/51059, filed on Jul. 28, 2021.
(60) Provisional application No. 63/057,876, filed on Jul. 28, 2020.

(51) Int. Cl. G06N 3/084

(52) U.S. Cl. CPC G06N 3/084

(57) ABSTRACT

Method and system for computing a total variation loss for use in backpropagation during training a neural network which individually classifies data points, comprising: predicting, using a neural network, a respective label for each data point in a set of input data points; determining a variation indicator that indicates a variance between: (i) smoothness of the predicted labels among neighboring data points and (ii) smoothness of the ground truth labels among the same neighboring data points; and computing the total variation loss based on the variation indicator.

### RELATED APPLICATIONS

This application is a continuation of International Application Number PCT/CA2021/051059 filed Jul. 28, 2021, and claims the benefit of and priority to U.S. Provisional Patent Application No. 63/057,876, filed Jul. 28, 2020 and entitled “SEMANTIC SEGMENTATION USING A TARGETED TOTAL VARIATION LOSS”, the contents of which are incorporated herein by reference.

### FIELD

The present disclosure generally relates to artificial intelligence, and in particular neural networks, and provides a method for computing a total variation loss for use in training a neural network which performs semantic segmentation (i.e. individually classifies data points).

### BACKGROUND

Computer vision is an integral part of various intelligent/autonomous systems in various fields, such as autonomous driving, autonomous manufacturing, inspection, and medical diagnosis. Computer vision is a field of artificial intelligence in which computers learn to interpret and understand the visual world using digital images. Using digital images generated by cameras, a computer can use a deep learning model to accurately “perceive” an environment (i.e. identify and classify objects) in the environment and react to what is “perceived” in the environment. For example, an autonomous vehicle has cameras mounted on the vehicle that capture images of the environment surrounding the vehicle during operation of the vehicle. A computer of the vehicle processes the digital images captured by the cameras.

Sematic segmentation is a machine learning (ML) technique that labels each pixel of a digital image with a corresponding class of what is being represented. Every pixel, belonging to the same class of object, is labelled as that object. For example, all people detected in an image that can be segmented as one object and all background (i.e., not people) as another object.

Semantic segmentation can also be applied in the context of point clouds generated by, for example, Light Detection and Ranging (LiDAR) sensors. Each data point in a point cloud can be labelled with a corresponding class of what is being represented.

Many known solutions for training an ML based semantic segmentation model focus on lowering a loss value that is based on a comparison of a predicted label output by the model for a data point (e.g., a pixel in the case of image data and a cloud point in the case of cloud point). Such solutions may focus only on the relationship of the label predicted for a data point to its ground-truth label, with little or no consideration for neighboring data points information. Some solutions perform averaging over all data points for the purpose of backpropagation, however even in such solutions information about neighboring data points is underutilized.

Classifying a pixel in an image or a data point in a point cloud can benefit heavily from the information provided by the neighboring data points (e.g., neighboring pixels in the case of image data and nearest neighbor data points in the case of a point cloud generated by a LiDAR sensor).

In order to benefit from neighboring data points, it is desirable to incorporate information provided by neighboring data points to improve the accuracy of a neural network which performs semantic segmentation.

### SUMMARY

According to first example aspect is a method for computing a total variation loss for use in backpropagation during training of a neural network which individually classifies data points, comprising predicting, using a neural network, a respective label for each data point in a set of input data points; determining a variation indicator that indicates a variance between: (i) smoothness of the predicted labels among neighboring data points and (ii) smoothness of the ground truth labels among the same neighboring data points; and determining a total variation loss value based on the variation indicator.

In at least some applications, a total variation loss value that incorporates a comparison of the predicted labels among neighboring data points and the ground truth labels among neighboring data points can improve the accuracy of a neural network that is trained to perform a semantic segmentation task.

In some examples of the preceding aspects of the method, determining the smoothness of the predicted labels among neighboring data points comprises determining differences in the predicted labels between the neighboring data points, and determining the smoothness of the ground truth labels among neighboring data points comprises determining differences in the ground truth labels between the neighboring data points.

In some examples of the preceding aspects of the method, determining the variation indicator comprises determining a norm of a difference between the smoothness of the predicted labels among neighboring data points and the smoothness of the ground truth labels among the same neighboring data points.

In some examples of the preceding aspect, the data points are image pixels, and neighboring data points are defined a by a defined pixel distance.

In some examples of the preceding aspect, the data points are point cloud data points of a point cloud and neighboring data points are defined by a nearest neighbor identification algorithm.

In some examples of the preceding aspect, the total variation loss value is incorporated into a loss function to determine a total loss value for the neural network, the method further comprising determining update values for plurality of parameters of the neural network as part of gradient decent training of the neural network.

According to a further example aspect is a method for determining a loss value for use in training a neural network to perform sematic segmentation, comprising: predicting, using a neural network, a respective label for each data point in a set of input data points; for each data point, determine: (i) a predicted label difference value between the predicted label for the data point and a predicted label for at least one neighbor data point of the data point; and (ii) a ground truth label difference value between a ground truth label for the data point and a ground truth label for the least one neighbor data point of the data point; for each data point, determine a difference indicator between the predicted label difference value and the ground truth label difference value; and assign a loss value based on a norm of the difference indicators.

According to a further aspect is a computer system comprising a processor and non-volatile memory coupled to the processor, the memory storing instructions that when executed by the processor configure the computer system to perform the method of any of the preceding aspects.

The present disclosure provides a method of computing a loss that improves efficiency in training a neural network constructed and arranged for semantic segmentation.

### BRIEF DESCRIPTION OF THE DRAWINGS

For a more complete understanding of example embodiments, and the advantages thereof, reference is now made to the following detailed description taken in conjunction with the accompanying drawings, in which:

FIG. 1 is a schematic diagram illustrating a machine learning system, in accordance with an example embodiment.

FIG. 2 shows a block diagram of a computing device that may be used to implement features of the machine learning system of FIG. 1.

Similar reference numerals may have been used in different figures to denote similar components.

### DETAILED DESCRIPTION

Embodiments of the present disclosure relate to a method for generating a loss value for use in training a neural network to individually classify data points. The trained neural network is constructed and arranged to individually classify data points. To benefit from the neighboring information available in a dataset and its labels, the present disclosure introduces a total variation loss that enables specific nearest neighbor information to be incorporated into a loss function. The disclosed loss function can, in some applications, improve the accuracy metrics for semantic segmentation and classification.

In this disclosure, data point can refer to a basic data element in a dataset, for example a pixel in a digital image or a cloud data point in a point cloud generated by a detection and ranging (DAR) sensor, such as a light detection and ranging (LiDAR) sensor. Neural Network (NN) can refer to a machine learning based computer-algorithm implemented model that is comprised of one or more convolutional NN layers, fully connected NN layers, activation functions, and other layers and operations. In the case of an NN for semantic classification, the layers and functions are collectively structured and arranged to approximate a function ƒ(.) that can individually classify data points or a subset of data points, depending on the task. For example, an NN can take an input x (which can be a W by H array of Red, Green, Blue (RGB) intensity values in the case of an image, or a point cloud set of data point values (x,y,z,intensity)) in the case of a LIDAR point cloud) and output the label prediction for all or a subset of the data points in the input x. For example some semantic NNs focus on classifying dynamic objects such as cars, motorcyclists and pedestrian only, and other semantic NNs might include classifying other types of objects such as roads, buildings and traffic signs.

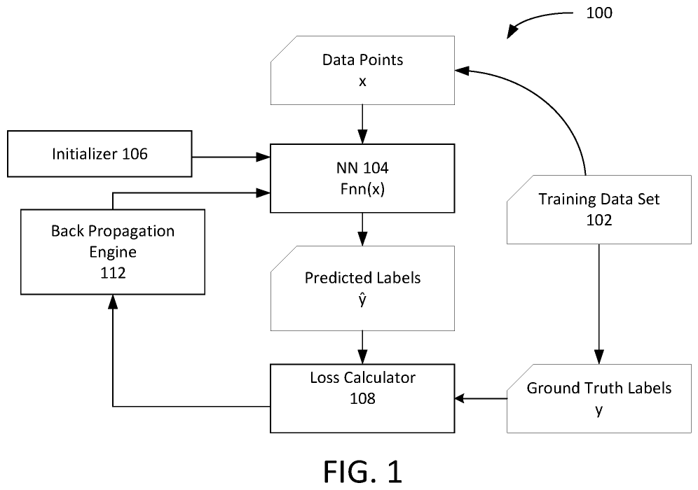

FIG. 1 is a block diagram of a computer implemented machine learning system 100 that includes a neural network 104. The neural network 104 is trained using a supervised learning process and a training data set 102 that includes training data in the form of images or point clouds, and a ground truth label y for each data point (e.g., each pixel in the case of an image or each cloud data point in the case of a point cloud). The neural network 104, which is constructed and arranged for semantic segmentation, approximates a model as follows:

ŷ=ƒ_{NN}(x)

in which, x is the input to the neural network, ƒ_{NN}(⋅) is a function approximated by the neural network 104, and ŷ is the prediction output by the neural network 104. The input x to the neural network 104 may be data points corresponding to a digital image or a point cloud. The prediction labels ŷ output by the neural network 104 includes a predicted class label for every pixel in the image when the input x is a digital image, or a predicted class label for every data point when the input x is a point cloud. The neural network 104 is trained using a supervised leaning algorithm and a training data set 102 in which each training data sample in the training data set 102 includes a set of data points corresponding to a digital image or a point cloud, and a ground truth label y that includes a ground truth label for every data point in the set of data points.

The input x to the neural network 104 can be in any suitable format for the designated task. In the case of an image classification task, the input x may be an image data with RGB channels of size (W, H), represented using a tensor of size (C, W, H), where C is the feature channel. Image data is structured data such that the location of the pixels (e.g. data points) in the (W,H) size matrix has structure and meaning. The neighbors of each pixel (e.g. data point) are defined by the location of that pixel (e.g. data point) in the matrix. The neighborhood size of a particular pixel (e.g. data point) can be defined by a step number (e.g. 1 step means pixels (e.g. data points) immediately adjacent to the subject pixel (e.g. data point).

In other examples the input x may be a point cloud generated by a detection and ranging sensor, such as a scanning light detection and ranging (LiDAR sensor. A point cloud is a set of data points in a three dimensional coordinate system that represent a three dimensional shape or feature. In such examples, the input x is the data points of the point cloud which may be unstructured such that neighbor data points can't be identified simply based on a relative location. A further computation, for example a k-nearest neighbor computation, may be required to identify neighbor data points of a data point of the point cloud.

A method of training the neural network 104 can begin with an initialization action during which the learnable parameters (e.g. weights and biases) of the neural network 104 are initialized using an initializer 106. Training data (input x) from the training data set 102 is provided as input to neural network 104. The neural network 104 predicts a respective labels y for each data point in a set of input data points.

According to aspects of the present disclosure, a total variation loss Vₗₒₛₛ(y,ŷ) is computed that is based on both a target data point as well as its neighboring data points. The total variation loss incorporates a summation of errors related both to the target data point as well as its neighboring data points. In an illustrative example, the total variation loss is computed as follows: for every data point within a neighboring group of data points: (a) compute the absolute values of the differences in predicted labels between each data point and its neighbors to determine a set of predicted label difference values; (b) compute the absolute values of the differences in the ground truth labels between each data point and its neighbors to determine a set of ground truth label difference values; (c) compute a norm of the difference between the set of predicted label difference values and the ground truth label difference values for each pair of data points within the neighboring group of data points; and (d) sum the computed norms to arrive at a loss for the input x.

In this regard, a loss calculator 108 which determines a total variation loss Vₗₒₛₛ(y,ŷ) can be described according to the following equations:

$${Y}_{\{ ( Δ i ) , ( j ) \}} = \vert {y}_{\{ ( i + Δ i ) , ( j ) \}} - {y}_{\{ i , j \}} \vert , ∀ i , j , Δ i ∈ ℤ \qquad ( 1 )$$

$${Y}_{\{ ( i ) , ( Δ j ) \}} = \vert {y}_{\{ ( i ) , ( j + Δ j ) \}} - {y}_{\{ i , j \}} \vert , ∀ i , j , Δ j ∈ ℤ \qquad ( 2 )$$

$${V}_{loss} ( y , \hat{y} ) = {\sum }_{{Δ}_{i} , {Δ}_{j}} {‖ {Y}_{( Δ i ) , ( j )} - {\hat{Y}}_{( Δ i ) , ( j )} ‖}_{p , q} + {‖ {Y}_{( i ) , ( Δ j )} - {\hat{Y}}_{( i ) , ( Δ j )} ‖}_{p , q} \qquad ( 3 )$$

$$∀ i , j , Δ i , Δ j ∈ ℤ , p , q \geq 1$$

where: Vₗₒₛₛ(y,ŷ) is the total variation loss, (i,j) is a data point index (e.g., pixel location in the case of image data), Δi,Δj are respective step values in data point index referring to the adjacent pixels or data point in a known coordinate system such as pixel domain for images, and Cartesian-coordinates for point clouds, y_{i,j} is the ground truth label for the data point at location (i,j), ŷ_{i,j} is the predicted label (output of the neural network 104), |⋅| is the absolute value function and ∥⋅∥_{p,q} is the p,q norm.

In an example embodiment, loss calculator 108 is configured to compute the total variation loss Vₗₒₛₛ(y,ŷ) as follows:

Step 1: If location indexes for neighbors are not inherently defined by the data structure (e.g., if data points are not structured data), identify the neighboring data points of each predicted data point (e.g. apply a k-nearest neighbor algorithm).

Step 2: Compute Equation (3) for all the values (y,ŷ) as one term for all the data points in the pair (y,ŷ). In more detail, for an arbitrary choice of ∀i,j,Δi,Δj∈ [symbol] , p,q≥1, execute the steps below to compute the loss Vₗₒₛₛ(y,ŷ):
i. For all data points (i,j) and values Δi and Δj:
   1. Compute the absolute value of y_{{(i+Δi),(j)}}−y_{{i,j}} and put it in tensor variable Y_{{(Δi),(j)}}
   2. Compute the absolute value of y_{{(i),(j+Δj)}}−y_{{i,j}} and put it in tensor variable Y_{{(i),(Δj)}}
   3. Compute the absolute value of ŷ_{{(i+Δi),(j)}}−ŷ_{{i,j}} and put it in tensor variable Ŷ_{{(i),(Δj)}}
   4. Compute the absolute value of ŷ_{{(i),(j+Δj)}}−ŷ_{{i,j}} and put it in tensor variable Ŷ_{{(i),(Δj)}}
ii. For all pairs of (Δi), (j):
   1. Compute the p,q norm of Y_{{(Δi),(j)}} and Ŷ_{{(Δi),(j)}}
iii. For all pairs of (i),(Δj):
   1. Compute the p,q norm of Y_{{(i),(Δj)}} and Ŷ_{{(i),(Δj)}}
iv. Sum all the values that were computed in steps (ii) and (iii) and put in variable Vₗₒₛₛ(y,ŷ) which presents the loss.

Step 4: In the event that the total variation loss Vₗₒₛₛ(y,ŷ) is one of multiple losses included in a main loss function, add the total variation loss Vₗₒₛₛ(y,ŷ) to a main loss function used for training the neural network 104, and compute the total loss (the total loss function usually is a combination of various loss functions). The total variation Vₗₒₛₛ(y,ŷ) can be used as the only loss term or in addition to other loss terms such as cross-entropy).

Step 5: Use a back propagation engine 112 to update the learnable parameters (e.g. weights and biases) of the neural network 104.

Backpropagation engine 112 can execute (or run) any known backpropagation techniques in machine learning to update the parameters (e.g. weights and biases) of the neural network 104 using aa loss (cost) function, such as the total variation Vₗₒₛₛ(y,ŷ), or the total loss function described above. Examples of backpropagation techniques include automatic gradient computation, and analytical gradient computation derived along with the equation to update the parameters (e.g. weights and biases) of the neural network 104.

In summary, a method for generating a total variation loss Vₗₒₛₛ(y,ŷ) for use during training of a neural network 104 which individually classifies data points, can include: predicting, using the neural network 104, a respective label y for each data point in a set of input data points; determining a variation indicator that indicates a variance between: (i) smoothness of the predicted labels ŷ among neighboring data points and (ii) smoothness of the ground truth labels y among the same neighboring data points; and determining the total variation loss Vₗₒₛₛ(y,ŷ) based on the variation indicator.

In an illustrative embodiment, point clouds are gathered in the context of a road vehicle to generate a set of point clouds. A training dataset is generated by obtaining ground truth labels for each of the data points included in each point cloud. The training dataset is then used to train NN 104. In an example embodiment, NN 104 has an architecture similar to the architecture of the SalsaNext model described in the reference: SalsaNext: Fast, Uncertainty-aware Semantic Segmentation of LiDAR Point Clouds for Autonomous Driving, March 2020, Tiago Cortinhal, George Tzelepis, Eren Erdal Aksoy, https://arxiv.org/abs/2003.03653. The loss function used to compute the total loss for the NN 104 by loss calculator 108 is:

Loss=Vₗₒₛₛ(y,ŷ)+Lovasz loss+weighted cross entropy

In at least some examples, the use of a NN 104 along with the above loss function can improve the accuracy of a NN 104 which performs semantic segmentation (i.e. individually classifies data points).

In example embodiments, the components, modules, systems and agents described above can be implemented using one or more computer devices, servers or systems that each include a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a digital signal processor, or another hardware processing circuit.

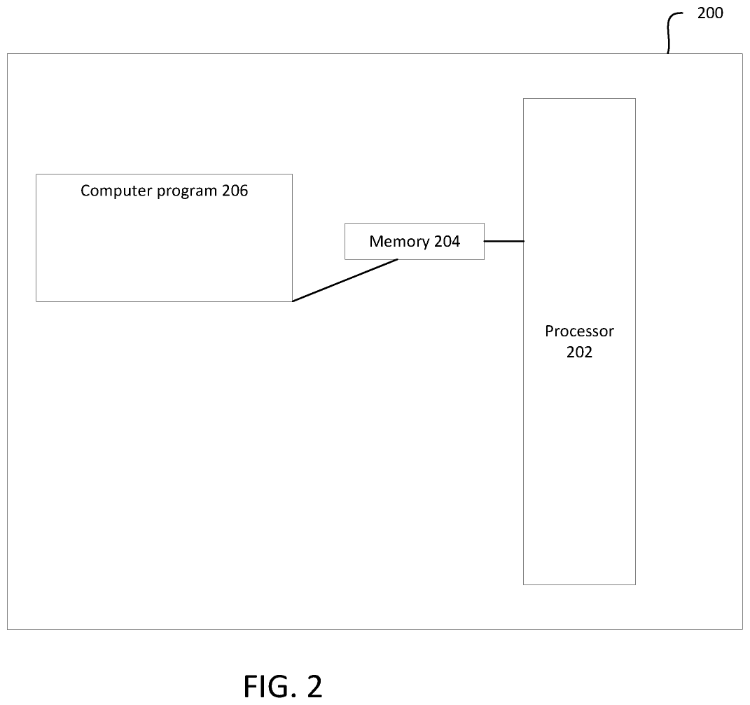

Referring to FIG. 2, a schematic hardware diagram of an example computing device 200 for implementing the method for computing a total variation loss and the method of training the neural network 104 will be described. The computing device 200 comprises at least one processor 202 which controls the overall operation of the computing device 200. Processor 202 may include one or more central processing units, graphical processing units, tensor processing units, AI enabled processing units, and related hardware accelerators. The processor 202 is coupled to a plurality of components via a communication bus (not shown) which provides a communication path between the components and the processor 202. The computing device 200 also comprises memory 204 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory.

The memory 204 stores a computer program 206 for training the neural network 104. The computer program 206 comprising computer-readable instructions that are executable by the processor 202. When the processor 202 executes the computer-readable instructions of the computer program 206, the methods of training the neural network 104 and/or the method for computing a total variation loss for use in backpropagation during the training of the neural network 104 as described herein is performed.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

What is claimed is:

1. A method for computing a total variation loss for use in backpropagation during training of a neural network which individually classifies data points, comprising:
predicting, using the neural network, a respective label for each data point in a set of input data points;
determining a variation indicator that indicates a variance between: (i) smoothness of the predicted labels among neighboring data points and (ii) smoothness of the ground truth labels among the same neighboring data points; and
computing a total variation loss based on the variation indicator.

2. The method of claim 1 wherein determining the smoothness of the predicted labels among neighboring data points comprises determining differences in the predicted labels between the neighboring data points, and determining the smoothness of the ground truth labels among neighboring data points comprises determining differences in the ground truth labels between the neighboring data points.

3. The method of claim 2 wherein determining the variation indicator comprises determining a norm of a difference between the smoothness of the predicted labels among neighboring data points and the smoothness of the ground truth labels among the same neighboring data points.

4. The method of claim 1 wherein the data points are image pixels, and neighboring data points are defined a by a defined pixel distance.

5. The method of claim 1 wherein the data points are point cloud data points of a point cloud and neighboring data points are defined by a nearest neighbor identification algorithm.

6. The method of claim 1 wherein the total variation loss is incorporated into a total loss function for the neural network to generate a total loss for the neural network, the method further comprising determining update values for plurality of parameters of the neural network as part of gradient decent training of the neural network.

7. A method for training a neural network which performs sematic segmentation, comprising:
predicting, using the neural network, a respective label for each data point in a set of input data points;
for each data point, determining: (i) a predicted label difference value between the predicted label for the data point and a predicted label for at least one neighbor data point of the data point; and (ii) a ground truth label difference value between a ground truth label for the data point and a ground truth label for the least one neighbor data point of the data point;
for each data point, determining a norm of a difference between the predicted label difference value and the ground truth label difference value;
computing a total variation loss for the set of input data points based on a sum of the norms; and
performing backpropagation to update a set of parameters of the neural network based at least on the total variation loss.

8. The method of claim 7 wherein:
determining the predicted label difference values comprises: for all the data points (i,j) and values Δi and Δj, where (i,j) is a data point index and Δi,Δj are respective step values in the data point index, computing an absolute value of y_{{(i+Δi),(j)}}−y_{{i,j}}, where y_{{i,j}} is the predicted label for data point (i,j) for inclusion in a corresponding location of a tensor variable Y_{{(Δi),(j)}}, and computing the absolute value of y_{{(i),(j+Δj)}}−y_{{i,j}} for inclusion in a corresponding location of a tensor variable Y_{{(Δi),(j)}};
determining the ground truth label difference values comprises: for all the data points (i,j) and values Δi and Δj, computing the absolute value of ŷ_{{(i+Δi),(j)}}−ŷ_{{i,j}}, where ŷ_{{i,j}} is the ground truth label for data point (i,j), for inclusion in a corresponding location of a tensor variable Ŷ_{{(i),(Δj)}}, and computing the absolute value of ŷ_{{(i),(j+Δj)}}−ŷ_{{i,j}} for inclusion in a corresponding location of a tensor variable Ŷ_{{(i),(Δj)}};
determining the norm of the difference indicators comprises: computing a first p,q norm of Y_{{(Δi),(j)}} and Ŷ_{{(Δi),(j)}} for all pairs of (Δi), (j) and computing a p,q norm of Y_{{(i),(Δj)}} and Ŷ_{{(i),(Δj)}} for all pairs of (i), (Δj).

9. The method of claim 7 wherein the set of input data points comprises an image.

10. The method of claim 7 wherein the set of input data points comprises data points of a point cloud.

11. A computer system comprising one or more processors and non-volatile memory coupled to the one or more processors, the memory storing instructions that when executed by the one or more processors configure the computer system to perform operations to compute a total variation loss for use in backpropagation during training of a neural network which individually classifies data points, the operations comprising:
predicting, using the neural network, a respective label for each data point in a set of input data points;
determining a variation indicator that indicates a variance between: (i) smoothness of the predicted labels among neighboring data points and (ii) smoothness of the ground truth labels among the same neighboring data points; and
computing a total variation loss based on the variation indicator.

12. The computer system of claim 11 wherein determining the smoothness of the predicted labels among neighboring data points comprises determining differences in the predicted labels between the neighboring data points, and determining the smoothness of the ground truth labels among neighboring data points comprises determining differences in the ground truth labels between the neighboring data points.

13. The computer system of claim 12 wherein determining the variation indicator comprises determining a norm of a difference between the smoothness of the predicted labels among neighboring data points and the smoothness of the ground truth labels among the same neighboring data points.

14. The computer system of claim 11 wherein the data points are image pixels, and neighboring data points are defined a by a defined pixel distance.

15. The computer system of claim 11 wherein the data points are point cloud data points of a point cloud and neighboring data points are defined by a nearest neighbor identification algorithm.

16. The computer system of claim 11 wherein the total variation loss is incorporated into a total loss function for the neural network to generate a total loss for the neural network, the method further comprising determining update values for plurality of parameters of the neural network as part of gradient decent training of the neural network.
